(19) United States
(12) Patent Application Publication
(10) Pub. No.: US 2014/0347864 A1
(43) Pub. Date: Nov. 27, 2014

(54) LIQUID CRYSTAL DISPLAY DEVICE

(71) Applicant: Funai Electric Co., Ltd., Osaka (JP)

(72) Inventor: Kazuaki KAWADA, Daito-shi (JP)

(73) Assignee: Funai Electric Co., Ltd., Osaka (JP)

(21) Appl. No.: 14/280,791

(22) Filed: May 19, 2014

(30) Foreign Application Priority Data
May 23, 2013 (JP) 2013-109254

(51) Int. Cl. F21K 99/00; F21V 29/00

(52) U.S. Cl. CPC F21K 9/50; F21V 29/22; F21V 29/004
USPC 362/294

(57) ABSTRACT

A liquid crystal display device includes a light source provided with a plurality of LEDs and an LED board on which the plurality of LEDs are mounted, a heatsink configured by a plate-shaped member that dissipates heat emitted by the plurality of LEDs, and a reflective member including a fixed region that is fixed by being sandwiched between the heatsink and the LED board of the light source and which reflects light from the LEDs.

### BACKGROUND OF THE INVENTION

1. Field of the Invention

The present invention relates to a liquid crystal display device.

2. Description of the Related Art

A liquid crystal display constituting one example of liquid crystal display devices is configured, for example, by including a liquid crystal panel, a light source (backlight), a control circuit that controls various constituent elements of the liquid crystal panel, a power supply circuit that supplies power to the liquid crystal panel, control circuit, or the like, and other components (for example, see Japanese Patent Application Laid-Open Publication No. 2009-81004).

The light source is configured, for example, by including a plurality of light-emitting diodes (LEDs) and an LED board (hereinafter referred to as “LED bar” as appropriate). The LED bar is configured by a rectangular plate-shaped member, for example, and the plurality of LEDs are lined up in a single row.

Furthermore, a reflective sheet that reflects light from the LEDs is generally provided on the light source (on the side of the liquid crystal panel).

FIG. 9 is a perspective view showing one portion of the light source.

As shown in FIG. 9, the light source 20 is configured by an LED board 22 on which a plurality of LEDs 21 are provided.

The light source 20 is fixed to the surface of a heatsink 18 which is a heat-dissipating member made of metal and formed on a case, and is configured such that the heat emitted by the LEDs 21 is dissipated.

Moreover, a reflective sheet 30 is provided on the LED board 22. Openings 31 that pass the LEDs 21 mounted on the LED board 22 are formed in the reflective sheet 30. The reflective sheet 30 is pressed against and fixed to the LED bar by using a holder 40.

However, with liquid crystal displays, there are demands for improving workability during the manufacturing processes and reducing the number of components. With the liquid crystal display device of Japanese Patent Application Laid-Open Publication No. 2009-81004, for example, the problem is that improvement in workability and a reduction in the number of components are inadequate.

### SUMMARY OF THE INVENTION

Preferred embodiments of the present invention provide a liquid crystal display device that improves workability during the manufacturing process and reduces the number of components.

A liquid crystal display device according to a preferred embodiment of the present invention includes a light source including a plurality of light-emitting elements and a substrate on which the plurality of light-emitting elements are mounted; a first plated-shaped heat-dissipating member configured to dissipate heat emitted by the plurality of light-emitting elements; and a reflective member including a fixed region that is fixed by being sandwiched between the first heat-dissipating member and the substrate of the light source and which reflects light from the plurality of light-emitting elements.

The reflective member preferably is fixed by being sandwiched between the substrate and the first heat-dissipating member, so there is no longer any need to provide a holder or separate element to fix the reflective member.

Therefore, it is possible to cut down the manufacturing process involving screw-fastening or other fixing process for the holder. Furthermore, because the holder is not required, the number of components is reduced.

For example, a liquid crystal display device according to a preferred embodiment of the present invention preferably includes a second heat-dissipating member which is a tape member disposed between the first heat-dissipating member and the light source and which transfers the heat emitted by the plurality of light-emitting elements to the side of the first heat-dissipating member, and the reflective member preferably includes an opening that is spaced from the second heat-dissipating member and has a surface area larger than the surface area of the second heat-dissipating member.

The reflective member preferably includes an opening configured such that the reflective member does not contact the second dissipating member, so it is possible to favorably prevent deformation or the like of the reflective member due to heat.

Moreover, the thickness of the second heat-dissipating member preferably is greater than the thickness of the reflective member.

Because the thickness of the second heat-dissipating member preferably is greater than the thickness of the reflective member, the reflective member is fixed loosely, which makes it possible to favorably prevent warping or the like of the reflective member caused by vibration of the case.

In addition, the substrate preferably is a white plate-shaped member.

By making the substrate white, it is possible to significantly reduce, minimize or prevent the effect of the reflective member being on the back surface of the substrate on the amount of reflected light from the light source.

Furthermore, the first heat-dissipating member may be provided with cut-and-raised portions that hold the substrate.

Various preferred embodiments of the present invention provide a liquid crystal display device with improved workability during the manufacturing process and a reduced number of components.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1A is an external appearance diagram showing one example of the external appearance of a liquid crystal display.

FIG. 1B is a diagram showing a disassembled state of the liquid crystal display shown in FIG. 1A.

FIG. 2 is a perspective view showing one example of the arrangement of the light source, heat-dissipating tapes, a reflective sheet, and a heatsink.

FIG. 3 is a diagram (partially enlarged diagram) showing one example of the configuration of the reflective sheet.

FIG. 4 is a diagram (overall diagram) showing one example of the configuration of the reflective sheet.

FIG. 5 is a sectional view showing one example of the relationship involving the arrangement of the light source, reflective sheet, and heatsink.

FIG. 6 is a diagram showing one example of the configuration of the cut-and-raised portions of the heatsink.

FIG. 7 is a diagram showing one example of another configuration of the reflective sheet.

FIG. 8 is a diagram showing one example of another configuration of the reflective sheet.

FIG. 9 is a perspective view showing one portion of the light source.

### DETAILED DESCRIPTION OF THE PREFERRED EMBODIMENTS

Preferred embodiments of the present invention will be described in detail below using drawings. Note that individual dimensions, dimensional ratios, and the like are not necessarily depicted in a strict sense in each figure.

Furthermore, each of the preferred embodiments to be described below represents a preferred specific example of the present invention. The numerical values, shapes, materials, constituent elements, the disposed positions and connection modes of the constituent elements, steps, the sequence of steps, and so forth indicated in the preferred embodiments below are merely non-limiting examples and do not limit the present invention. The present invention is specified by the scope of the claims.

### Preferred Embodiment 1

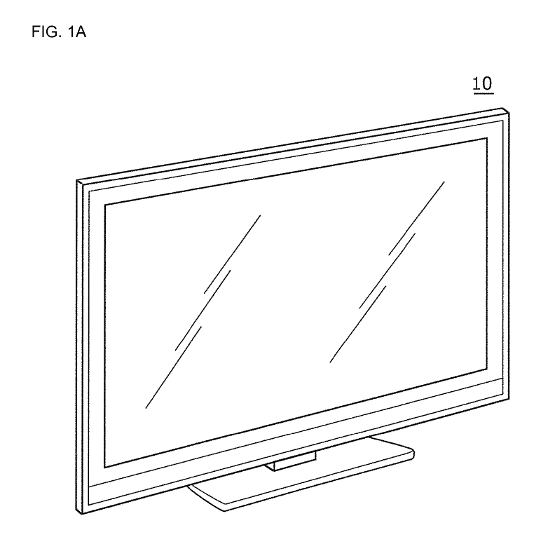

The liquid crystal display of Preferred Embodiment 1 will be described based on FIGS. 1A through 6.

The liquid crystal display of the present preferred embodiment is preferably configured so as to fix a reflective sheet by sandwiching it between an LED board (substrate) and a heatsink.

A liquid crystal display 10 according to the present preferred embodiment will be described based on FIGS. 1A and 1B. FIG. 1A is an external appearance diagram showing one example of the external appearance of the liquid crystal display 10 constituting one example of the liquid crystal display device. FIG. 1B is a diagram showing a disassembled state of the liquid crystal display 10 shown in FIG. 1A.

The liquid crystal display 10, as shown in FIG. 1B, includes a front cabinet 11, a bezel 12, an open cell 13, a cell guide 14, optical members 15, a light source 20, heat-dissipating tapes 23 (not shown in FIG. 1B), a reflective member 16, a rear frame 17, and a heatsink 18 (not shown in FIG. 1B).

The front cabinet 11 and the rear frame 17 constitute a case of the liquid crystal display 10 preferably made of resin in the present preferred embodiment.

The bezel 12 is a member that supports the open cell 13.

The open cell 13 includes a liquid crystal panel, a COF (chip-on-film or chip-on-flexible), and a PCB (printed circuit board). The COF is a flexible cable on which an IC (integrated circuit) that drives the liquid crystal panel is mounted. The IC generates drive signals that drive the liquid crystal panel based on signals that are input from a control circuit (not shown) via the PCB.

The cell guide 14 is a member configured to prevent the open cell 13 from positionally shifting.

The optical members 15 are members configured to adjust the luminance or the like of light from the light source and are configured from optical sheets and a diffusing plate.

The light source 20, heat-dissipating tapes 23, reflective member 16, and heatsink 18 will be described below.

The light source 20 is a backlight for the liquid crystal display 10 and is attached to the heatsink 18 via the heat-dissipating tapes 23.

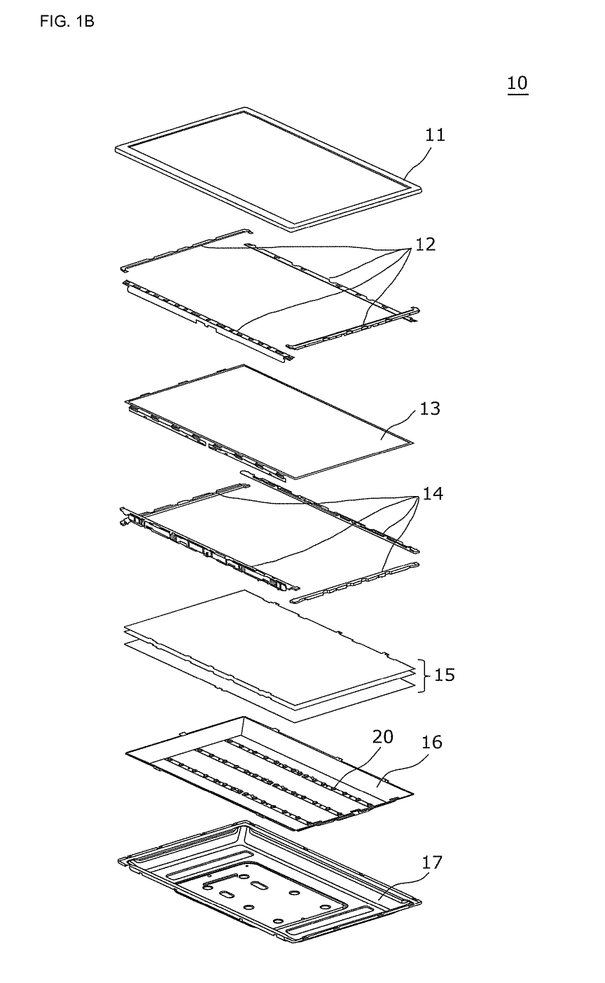

FIG. 2 is a perspective view showing one example of the arrangement of the light source 20, the heat-dissipating tapes 23, a reflective sheet 16A, and the heatsink 18.

The light source 20 includes a plurality of LEDs 21 and an LED board 22 on which the plurality of LEDs 21 are mounted as shown in FIG. 2.

The LED board 22 is one example of the substrate and is preferably configured by a rectangular or substantially rectangular plate-shaped member as shown in FIG. 2. The surface of the LED board 22 on which the LEDs 21 are installed is white, which tends to reflect light. The LED board 22 preferably includes a white resist, for example. Moreover, although this is not shown in FIG. 2, the LED board 22 of the light source 20 preferably includes, at its end portions, signal wiring which accepts control signals from a control circuit that controls lighting, extinguishing, and the like of the LEDs 21, power supply wiring which accepts supply of power from a power supply circuit, and so forth.

The LEDs 21 are just one example of light-emitting elements and preferably are lined up on the LED board 22 in a single row at equal or substantially equal intervals along the long sides of the LED board 22.

The heat-dissipating tapes 23 constitute one example of the second heat-dissipating member that preferably is a tape member that dissipates heat emitted by the LEDs 21 to the heatsink 18. In the present preferred embodiment, the heat-dissipating tapes 23 are provided on the side (back side) on which the LEDs 21 are not installed so as to respectively correspond to the LEDs 21 as shown in FIG. 2. In the present preferred embodiment, the heat-dissipating tapes 23 preferably have a rectangular or substantially rectangular shape and disposed such that a pair of opposing sides overlap with the long sides of the LED board 22.

In addition, the thickness of the heat-dissipating tapes 23 is preferably greater than the thickness of the reflective sheet 16A in the present preferred embodiment. As a result, the reflective sheet 16A is loosely fixed in the present preferred embodiment. This makes it possible to prevent problems such as the positional shift of the reflective sheet 16A caused by vibration or the like of the case or warping of the reflective sheet 16A caused by expansion or the like of the reflective sheet 16A due to heat.

The reflective sheet 16A is one example of the reflective member that preferably is a sheet-shaped member that reflects light from the LEDs. The reflective sheet 16A of the present preferred embodiment is disposed between the LED board 22 and the heatsink 18.

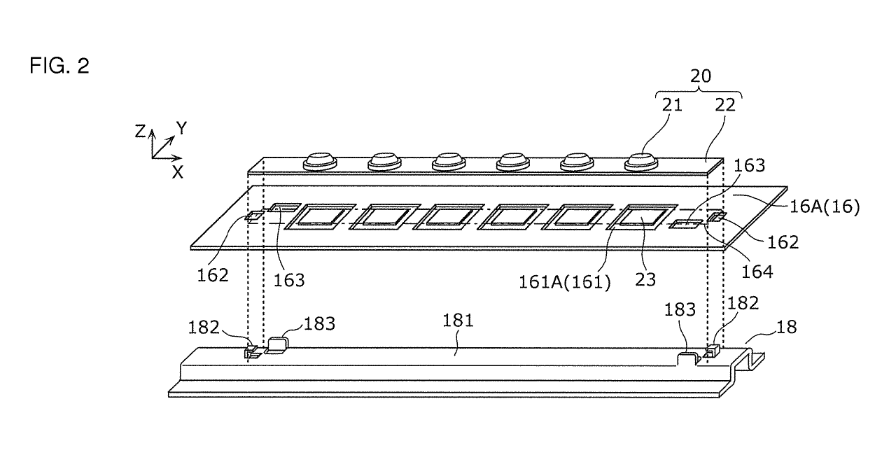

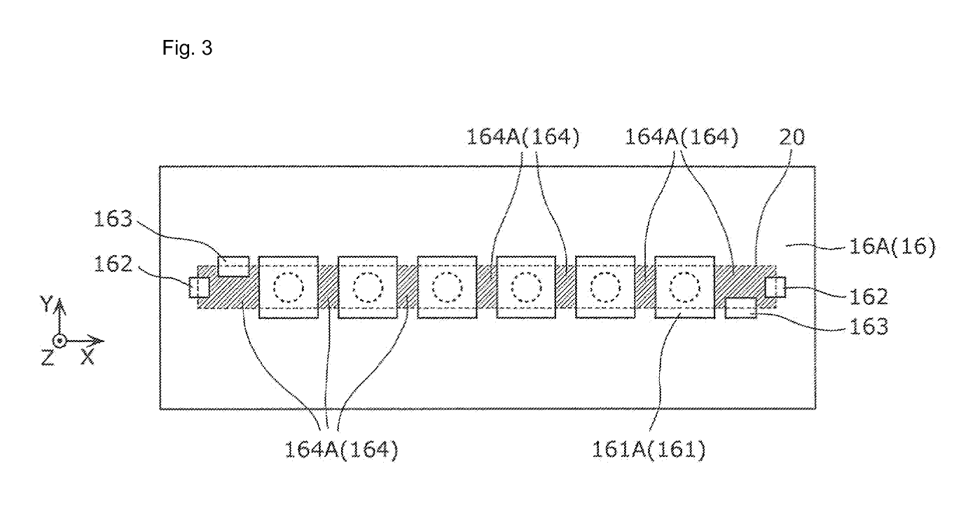

FIG. 3 is a diagram showing one example of a portion of the configuration of the reflective sheet 16A. FIG. 4 is a diagram showing the overall configuration of the reflective sheet 16A shown in FIG. 3. In FIGS. 3 and 4, the portions where the light source 20 is disposed are indicated by dotted lines for the sake of illustration. The reflective sheet 16A will be described below with reference to FIGS. 2 through 4.

As shown in FIGS. 2 and 3, openings 161A (161) are preferably provided in the reflective sheet 16A in positions in which the heat-dissipating tapes 23 (described later) are to be disposed. The reflective sheet 16A is also preferably provided with openings 162 and openings 163 in positions in which cut-and-raised portions 182 and 183 of the heatsink (described later) are to be disposed.

Note that the sizes of the openings 161A, 162, and 163 preferably are respectively larger than the sizes of the heat-dissipating tapes 23 and cut-and-raised portions 182 and 183. Furthermore, the positions of the openings 161A, 162, and 163 are such that the reflective sheet 16A does not contact the heat-dissipating tapes 23 and the cut-and-raised portions 182 and 183. With such a configuration, even if vibration of the case or other such factors cause the position of the reflective sheet 16A to be shifted with respect to the heatsink 18, warping or the like of the reflective sheet 16A is reliably prevented. In particular, if the openings 161A are arranged such that the reflective sheet 16A does not contact the heat-dissipating tapes 23, it is possible to reliably prevent the reflective sheet 16A from deforming due to the heat from the heat-dissipating tapes 23.

As shown in FIG. 3, the reflective sheet 16A preferably includes fixed regions 164A (164) (hatched portions in the figure) that are sandwiched between the LED board 22 and the heatsink 18.

Note that, for the sake of illustration, FIG. 3 shows one portion of the reflective sheet 16A which is a portion that corresponds to a single light source 20. In reality, a single reflective sheet 16A preferably is provided with fixed regions 164A and openings 161A, 162, and 163 that correspond to a plurality of light sources 20 as shown in FIG. 4, for example. FIG. 4 shows a case in which 3×2 light sources 20 are disposed in a matrix, for example. The numbers, shapes, positions, and the like of the fixed regions 164A and openings 161A, 162, and 163 are set in accordance with the arrangement of the light source 20 and the configuration of the heatsink 18.

The heatsink 18 is one example of the first heat-dissipating member that preferably is a member configured to dissipate the heat of the light source 20. The heatsink 18 is configured by a material with high thermal conductivity, such as metal. The heatsink 18 is provided on the inside of the rear frame 17.

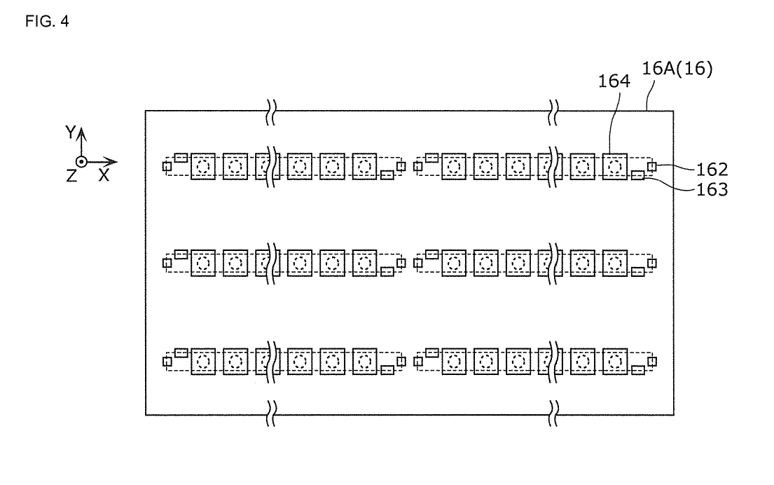

FIG. 5 is a sectional view of the reflective sheet 16A, heatsink 18, and light source 20 that is in a state in which the light source 20 is attached to the heatsink 18.

In more specific terms, the heatsink 18 includes a rectangular or substantially rectangular flat plate 181 that is in contact with the LED board 22 via the heat-dissipating tapes and is configured such that a ventilation passage 190 is provided between the flat plate 181 and the rear frame 17 as shown in FIG. 5.

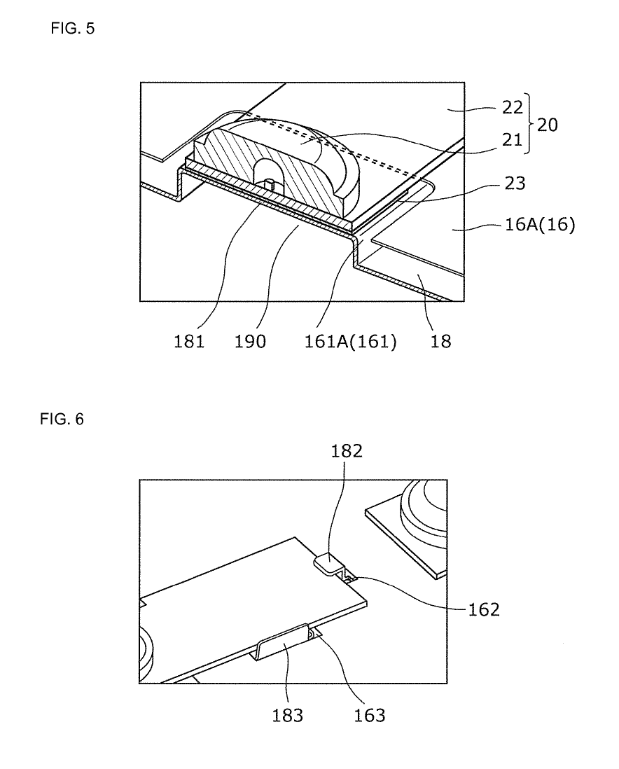

Moreover, the heatsink 18 preferably is provided with the cut-and-raised portions 182 and 183 to hold the LED board 22. FIG. 6 is a diagram showing a configuration example of the cut-and-raised portions 182 and 183.

As shown in FIG. 6, each of the cut-and-raised portions 182 includes a first plate that is perpendicular or substantially perpendicular to the flat plate 181 and a second plate that extends from the tip end (on the side opposite from the flat plate 181) of the first plate toward the side on which the LED board 22 is to be installed. In addition, in the present preferred embodiment, the pair of cut-and-raised portions 182 are provided so as to hold the short sides of the LED board 22 therebetween. If such a configuration is adopted, the pair of first plates make it possible to restrict the movement of the LED board 22 in the direction of the long sides of the flat plate 181. Furthermore, by sandwiching the LED board 22 between the second plates and the flat plate 181, it is possible to restrict the movement of the LED board 22 in the direction perpendicular or substantially perpendicular to the flat plate 181.

Each of the cut-and-raised portions 183 preferably includes a third plate that is perpendicular or substantially perpendicular to the flat plate 181. Moreover, in the present preferred embodiment, the pair of cut-and-raised portions 183 are configured so as to hold the long sides of the LED board 22 therebetween. The pair of cut-and-raised portions 183 make it possible to restrict the movement of the LED board 22 in the direction of the short sides of the flat plate 181.

The liquid crystal display device (liquid crystal display 10) of the present preferred embodiment preferably is configured such that the reflective sheet 16A is fixed by being sandwiched between the LED board 22 and the heatsink 18, which therefore eliminates the need to provide a holder 40 or the like.

Because of this, it is possible to significantly reduce the manufacturing process involving the screw-fastening or other process for the holder 40. In addition, because the holder 40 is not necessary, the number of components is reduced.

Note that the reflective sheet 16A preferably is disposed on the light source 20 on the side of the rear frame 17 in the present preferred embodiment, so it is considered that the surface area which can reflect light becomes small, which reduces the amount of reflected light. However, because the surface area of the reflective sheet 16A that is covered by the light source 20 is small, the effect is considered to be extremely small. Furthermore, as was described above, light is reflected to a certain extent by making the surface of the LED board 22 white, so the effect of the reflective sheet 16A being covered by the light source 20 is even smaller.

### Preferred Embodiment 2

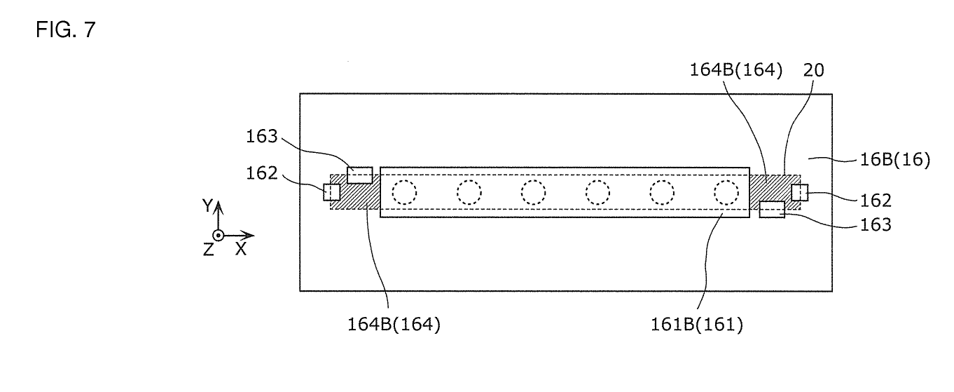

The liquid crystal display of Preferred Embodiment 2 will be described based on FIG. 7.

The liquid crystal display of the present preferred embodiment preferably is configured so as to fix the reflective sheet by sandwiching it between the LED board and the heatsink, just as in Preferred Embodiment 1.

The liquid crystal display 10 of the present preferred embodiment will be described based on FIGS. 1A and 1B.

The liquid crystal display 10 of the present preferred embodiment, just as in Preferred Embodiment 1, preferably includes a front cabinet 11, a bezel 12, an open cell 13, a cell guide 14, optical members 15, a light source 20, a heat-dissipating tape 23, a reflective member 16, a rear frame 17, and a heatsink 18.

Note that the configurations of the components other than the reflective member 16, i.e., the configurations of the front cabinet 11, bezel 12, open cell 13, cell guide 14, optical members 15, light source 20, heat-dissipating tape 23, rear frame 17, and heatsink 18, are preferably the same or substantially the same as in Preferred Embodiment 1.

The reflective sheet 16B of the present preferred embodiment will be described based on FIG. 7. FIG. 7 is a diagram showing the configuration of the reflective sheet 16B.

The reflective sheet 16B of the present preferred embodiment differs from the reflective sheet 16A of Preferred Embodiment 1 by the shape of an opening 161B.

As shown in FIG. 7, a single rectangular or substantially rectangular opening 161B is provided for a single light source 20 in the reflective sheet 16B of the present preferred embodiment. The opening 161B is preferably configured such that the length of the short sides is greater than the length of the short sides of the LED board 22. Moreover, the opening 161B is set such that the length of the long sides is smaller than the length of the long sides of the LED board 22 and also greater than the length of the entire heat-dissipating tape that comes in contact with the LED board 22.

In the present preferred embodiment, portions corresponding to the two end portions of the LED board 22 are set as fixed regions 164B as shown in FIG. 7.

The configurations of the openings 162 and 163 are preferably the same as in Preferred Embodiment 1.

The liquid crystal display device (liquid crystal display 10) of the present preferred embodiment preferably is configured so as to fix the reflective sheet 16B by sandwiching it between the LED board 22 and the heatsink 18 just as in Preferred Embodiment 1, so there is no longer need to provide the holder 40 or the like.

Therefore, the manufacturing process involving the screw-fastening or other process for the holder 40 is eliminated. In addition, because the holder 40 is not required, the number of components is reduced.

Furthermore, a single opening 161B preferably is provided for a single light source 20 in the present preferred embodiment, so the design of the reflective sheet 16B becomes easier. Note that the surface area of the fixed regions 164B of the reflective sheet 16B in the present preferred embodiment is smaller than the surface area of the fixed regions 164A of the reflective sheet 16A in Preferred Embodiment 1. However, in cases where the length of the LED board 22 is not very large, it is considered that the reflective sheet 16B is fixed in a favorable manner even if no fixed region 164A is provided between the individual LEDs 21.

### Preferred Embodiment 3

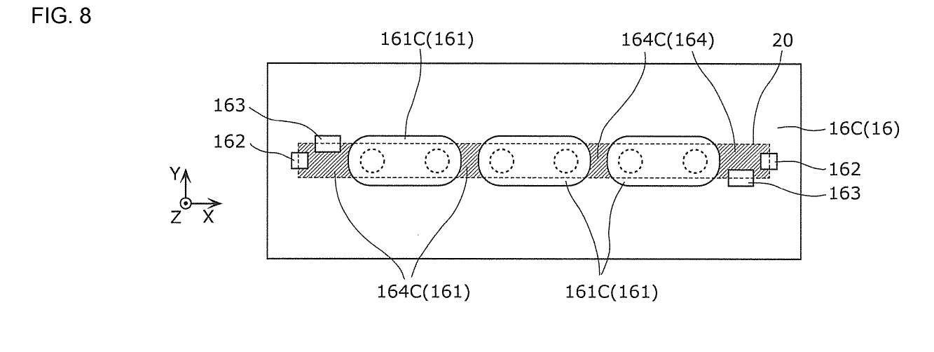

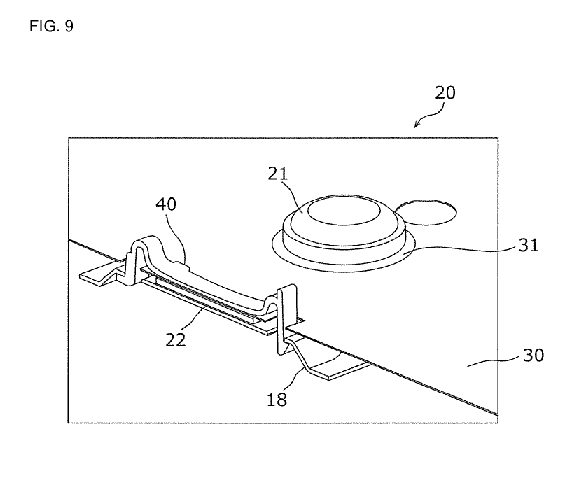

The liquid crystal display of Preferred Embodiment 3 will be described based on FIG. 8.

The liquid crystal display of the present preferred embodiment is configured so as to fix the reflective sheet by sandwiching it between the LED board and the heatsink just as in Preferred Embodiment 1 and Preferred Embodiment 2.

The liquid crystal display 10 of the present preferred embodiment will be described based on FIGS. 1A and 1B.

The liquid crystal display 10 of the present preferred embodiment, just as in Preferred Embodiment 1 and Preferred Embodiment 2, includes a front cabinet 11, a bezel 12, an open cell 13, a cell guide 14, optical members 15, a light source 20, heat-dissipating tapes 23, a reflective member 16, a rear frame 17, and a heatsink 18.

Note that the configurations of the components other than the reflective member 16, i.e., the configurations of the front cabinet 11, bezel 12, open cell 13, cell guide 14, optical members 15, light source 20, heat-dissipating tapes 23, rear frame 17, and heatsink 18, are preferably the same or substantially the same as in Preferred Embodiment 1 and Preferred Embodiment 2.

The reflective sheet 16C of the present preferred embodiment will be described based on FIG. 8. FIG. 8 is a diagram showing the configuration of the reflective sheet 16C.

As shown in FIG. 8, a single elliptical or substantially elliptical opening 161C is preferably provided for each set of a plurality of LEDs 21 in the reflective sheet 16C of the present preferred embodiment. In FIG. 8, two LEDs 21 are preferably arranged to define one set, and one opening 161C is preferably provided for every two LEDs 21 in the reflective sheet 16C.

In the present preferred embodiment, portions that correspond to the two end portions of the LED board 22 and regions between the individual openings 161C preferably are configured as fixed regions 164C as shown in FIG. 8.

The configurations of the openings 162 and 163 are preferably the same or substantially the same as in Preferred Embodiment 1.

The liquid crystal display device (liquid crystal display 10) of the present preferred embodiment preferably is configured so as to fix the reflective sheet 16C by sandwiching it between the LED board 22 and the heatsink 18 just as in Preferred Embodiment 1 and Preferred Embodiment 2, which therefore eliminates any need to provide the holder 40 or the like.

Because of this, it is possible to eliminate the manufacturing process involving the screw-fastening or other process for the holder 40. Moreover, because the holder 40 is not required, the number of components is reduced.

In addition, in the present preferred embodiment, a single opening 161C preferably is provided for every set of LEDs 21, so the design of the reflective sheet 16C becomes easier. Furthermore, the surface area of the fixed regions 164C of the reflective sheet 16C is larger than the surface area of the fixed regions 164B of the reflective sheet 16B in Preferred Embodiment 2, so it is considered that the reflective sheet 16C is fixed in a favorable manner even when the LED board 22 is considerably long.

The liquid crystal display devices according to preferred embodiments of the present invention were described above, but the present invention is not limited to these preferred embodiments.

In Preferred Embodiments 1 through 3 above, the openings provided in the reflective sheet preferably have a rectangular or substantially rectangular shape or an elliptical or substantially elliptical shape, for example, but the shape is not limited to this. Circular, substantially circular, square, substantially square, or any other shapes may also be used.

In Preferred Embodiments 1 through 3 above, the surface of the LED board 22 preferably is white, but the color is not limited to this. The surface of the LED board 22 may also be configured by a material and color that tend to reflect light.

In Preferred Embodiments 1 through 3 above, the description of the light source 20 is preferably provided with reference to a configuration in which the LEDs 21 are lined up in a single row at equal intervals, but the configuration is not limited to this. The LEDs 21 may also be aligned not at equal intervals but in an irregular manner or may also be aligned in a plurality of rows. The number and arrangement of the LEDs 21 are arbitrary.

In Preferred Embodiments 1 through 3 above, a case was described in which the heatsink 18 preferably is a separate unit from the rear frame 17, but the formation of the heatsink is not limited to this. In cases where the rear frame 17 is formed from a material having good thermal conductivity, the heatsink 18 may also be formed integrally with the rear frame 17 by the same member so as to define a single unitary element, for example.

In Preferred embodiments 1 through 3 above, the heatsink 18 preferably is provided with a pair of cut-and-raised portions 182 and a pair of cut-and-raised portions 183 for a single light source 20, but this number is not limited to this. The heatsink 18 may also be provided with a larger number of cut-and-raised portions 182 and 183 for a single light source 20.

In Preferred Embodiments 1 through 3 above, the heat-dissipating tapes 23 preferably has a rectangular or substantially rectangular shape, but the shape is not limited to this. Any shape may be used such as the shape that is the same as the shape of the LEDs 21 (e.g., circle).

In Preferred Embodiments 1 through 3 above, a case was described in which six LEDs 21 preferably are provided within the liquid crystal display 10, but this number is not limited to this. The number of the LEDs 21 may preferably be set in accordance with the size of the liquid crystal display 10, the size of the light source 20, and so forth.

Furthermore, it is also possible to combine each of the preferred embodiments and the modified examples.

Various preferred embodiments of the present invention are useful for liquid crystal display devices (liquid crystal displays) and especially for liquid crystal display devices including a light source, a heatsink, and a reflective sheet.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A liquid crystal display device comprising:
a light source including a plurality of light-emitting elements and a substrate on which the plurality of light-emitting elements are mounted;
a first heat-dissipating member that includes a plate configured to dissipate heat emitted by the plurality of light-emitting elements; and
a reflective member including a fixed region that is fixed by being sandwiched between the first heat-dissipating member and the substrate of the light source and which is configured to reflect light from the plurality of light-emitting elements.

2. The liquid crystal display device according to claim 1, further comprising a second heat-dissipating member that is a tape disposed between the first heat-dissipating member and the light source and is configured to transfer heat emitted by the plurality of light-emitting elements to a side of the first heat-dissipating member; wherein
the reflective member is provided with an opening spaced from the second heat-dissipating member and having a surface area that is larger than a surface area of the second heat-dissipating member.

3. The liquid crystal display device according to claim 2, wherein a thickness of the second heat-dissipating member is greater than a thickness of the reflective member.

4. The liquid crystal display device according to claim 1, wherein the substrate is a white plate.

5. The liquid crystal display device according to claim 1, wherein the first heat-dissipating member is provided with cut-and-raised portions configured to hold the substrate.

6. The liquid crystal display device according to claim 1, wherein first heat-dissipating member is a heat sink.

7. The liquid crystal display device according to claim 1, wherein the plurality of light-emitting elements are arranged in a single row at equal or substantially equal intervals on the substrate.

8. The liquid crystal display device according to claim 1, wherein the second heat-dissipating member includes heat-dissipating tapes having a rectangular or substantially rectangular shape and disposed such that a pair of opposing sides thereof overlap with long sides of the substrate.

9. The liquid crystal display device according to claim 1, wherein the second heat-dissipating member includes heat-dissipating tapes and the reflective sheet includes a plurality of openings located at positions of the heat-dissipating tapes.

10. The liquid crystal display device according to claim 9, wherein each of the plurality of openings is larger than each of the heat-dissipating tapes.

11. The liquid crystal display device according to claim 1, wherein the first heat-dissipating member includes cut-and-raised portions and the reflective sheet includes a plurality of openings located at positions of the cut-and-raised portions.

12. The liquid crystal display device according to claim 11, wherein each of the plurality of openings is larger than each of the cut-and-raised portions.

13. The liquid crystal display device according to claim 11, wherein each of the cut-and-raised portions includes a first plate and a second plate extending from a tip end of the first plate.

14. The liquid crystal display device according to claim 13, wherein each of the cut-and-raised portions further includes a third plate.

15. The liquid crystal display device according to claim 1, wherein the reflective sheet includes a rectangular or substantially rectangular opening.

16. The liquid crystal display device according to claim 1, wherein the reflective sheet includes an elliptical or substantially elliptical opening.

17. The liquid crystal display device according to claim 1, wherein the reflective sheet includes an opening that is circular, substantially circular, square, or substantially square.

18. The liquid crystal display device according to claim 1, wherein the substrate is a plate made of a material and having a color configured to reflect light.

19. The liquid crystal display device according to claim 1, wherein the plurality of light-emitting elements are arranged in a plurality of rows at equal or unequal intervals on the substrate.

20. The liquid crystal display device according to claim 1, further comprising a frame, wherein the first heat-dissipating member is integral with the frame.
